(19) United States
(12) Patent Application Publication
(10) Pub. No.: US 2005/0237348 A1
(43) Pub. Date: Oct. 27, 2005

(54) Method of dot size determination by an imaging apparatus

(76) Inventor: Michael Clark Campbell, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/832,836

(22) Filed: Apr. 27, 2004

(51) Int. Cl. B41J 29/38; B41J 2/205

(52) U.S. Cl. 347/6; 347/15

(57) ABSTRACT

A method of dot size determination includes the steps of printing a pattern on a print medium that changes in dot density along a scan path; scanning a reflectance sensor across the pattern to determine a reflectivity of the pattern at a plurality of points along the scan path; determining a change of the reflectivity along the scan path; and correlating the change in the reflectivity to a dot size.

### BACKGROUND OF THE INVENTION

1. Field of the Invention

The present invention relates to an imaging apparatus, and, more particularly, to a method of dot size determination by an imaging apparatus.

2. Description of the Related Art

An imaging apparatus forms an image on a print medium, such as for example, paper or a transparency, by applying ink or toner onto the print medium. The ink or toner is applied as a series of dots, which when viewed as a whole represent the image. The size of the dots formed on the print medium may be dependent on one or more of a variety of factors. For example, in an ink jet printer, the size of ink dots formed may be dependent on the nozzle opening size, temperature, fire energy, ink type, actuator type (e.g., an electrical heater), the location of the actuator relative to the nozzle opening, and print medium characteristics. In a laser printer, the size of dots formed may be dependent, for example, on the laser energy, the characteristics of the photoconductive surface, the voltage applied to the photoconductive surface, and temperature.

By knowing the amount of imaging substance, e.g., ink or toner, forming each dot, and by counting the number of dots formed, an estimate of the amount of imaging substance that has been used can be obtained. In turn, by knowing the amount of imaging substance prior to imaging, a remaining amount of imaging substance, i.e., level, in a supply item can be determined by subtracting the amount of imaging substance used from the amount of imaging substance that was present prior to imaging.

One challenge to be overcome in providing an accurate imaging substance level determination in a supply item is being able to account for imaging substance dot mass variations due to changed imaging conditions and/or imaging apparatus settings. Accordingly, the more accurate the imaging substance dot mass estimate, the more accurate the imaging substance level determination. In ink jet printing, for example, it is generally accepted that the ink dot mass is directly proportional to the ink dot size on the print medium, but ink dot size may vary due to the changes in imaging conditions and/or imaging apparatus settings described above.

What is needed in the art is a method of dot size determination that can be used under a variety of imaging conditions and/or imaging apparatus settings.

### SUMMARY OF THE INVENTION

The present invention provides a method of dot size determination that can be used under a variety of imaging conditions and/or imaging apparatus settings.

The invention in one form thereof, relates to a method of dot size determination. The method includes the steps of printing a pattern on a print medium that changes in dot density along a scan path; scanning a reflectance sensor across the pattern to determine a reflectivity of the pattern at a plurality of points along the scan path; determining a change of the reflectivity along the scan path; and correlating the change in the reflectivity to a dot size.

An advantage of the present invention is that an accurate dot size determination can be achieved at various imaging conditions (e.g., temperatures) and/or imaging apparatus settings (e.g., fire energies for ink jet imaging). Such an accurate dot size determination may be used, for example, for accurate imaging substance level determinations, or may be used to adjust halftoning algorithms and/or color tables to optimize the quality of the printed output.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a diagrammatic depiction of an imaging system embodying the present invention.

FIG. 2 is a flowchart depicting a general method of dot size determination in accordance with the present invention.

FIG. 3 is a combined pictorial diagram and graph illustrating a relationship between the dot density of a printed pattern and a reflectivity of the printed pattern.

FIG. 4 is a combined pictorial diagram and graph illustrating a relationship between the dot density of another printed pattern and a reflectivity of the printed pattern.

FIG. 5 is a combined pictorial diagram and graph illustrating a relationship between the dot density of still another printed pattern and a reflectivity of the printed pattern.

FIG. 6 is a graph that illustrates an exemplary relationship between printhead carrier velocity and fire time for the nozzles of a printhead, which may be used in generating the printed patterns of FIGS. 3-5.

FIG. 7 is a combined pictorial diagram and graph illustrating a relationship between the dot density of a continuous printed pattern and a reflectivity of the printed pattern.

FIG. 8 is a graph that illustrates an exemplary relationship between printhead carrier velocity and fire time for the nozzles of a printhead, which may be used in generating the printed pattern of FIG. 7.

FIG. 9 is a graph that illustrates an exemplary relationship between printhead carrier velocity and fire time for the nozzles of a printhead, as an alternative to that shown in FIG. 8.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

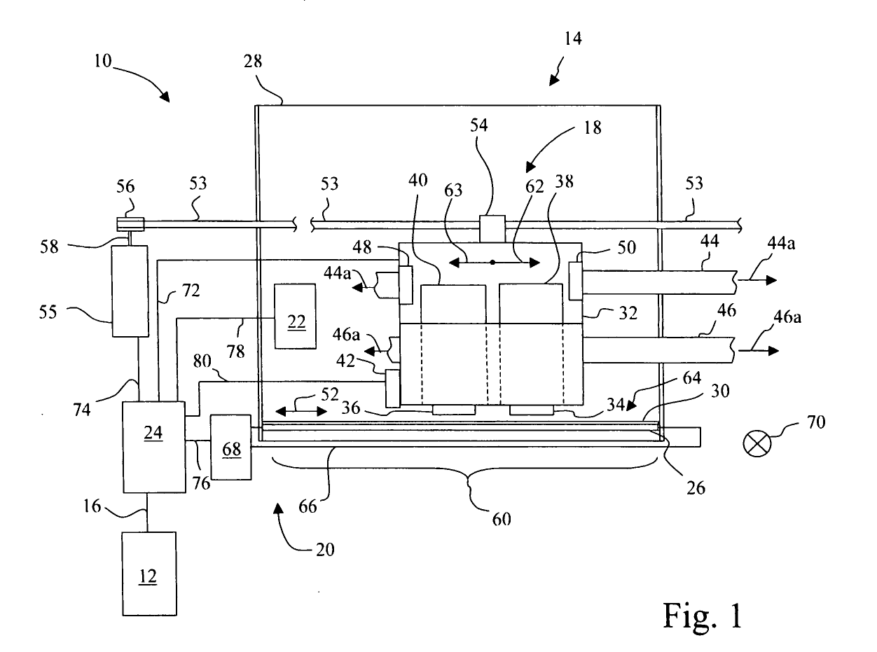

Referring now to the drawings, and particularly to FIG. 1, there is shown an imaging system 10 embodying the present invention. Imaging system 10 may include a host 12, or alternatively, imaging system 10 may be a standalone system.

Imaging system 10 includes an imaging apparatus 14, which may be in the form of an ink jet printer, as shown. Thus, for example, imaging apparatus 14 may be a conventional ink jet printer, or may form the print engine for a multi-function apparatus, such as for example, a standalone unit that has faxing and copying capability, in addition to printing.

Host 12, which may be optional, may be communicatively coupled to imaging apparatus 14 via a communications link 16. Communications link 16 may be, for example, a direct electrical connection, a wireless connection, or a network connection.

In embodiments including host 12, host 12 may be, for example, a personal computer including a display device, an input device (e.g., keyboard), a processor, input/output (I/O) interfaces, memory, such as RAM, ROM, NVRAM, and a mass data storage device, such as a hard drive, CD-ROM and/or DVD units. During operation, host 12 includes in its memory a software program including program instructions that function as a printer driver for imaging apparatus 14. The printer driver is in communication with imaging apparatus 14 via communications link 16. The printer driver, for example, includes a halftoning unit and a data formatter that places print data and print commands in a format that can be recognized by imaging apparatus 14. In a network environment, communications between host 12 and imaging apparatus 14 may be facilitated via a standard communication protocol, such as the Network Printer Alliance Protocol (NPAP).

In the embodiment of FIG. 1, imaging apparatus 14, in the form of an ink jet printer, includes a printhead carrier system 18, a feed roller unit 20, a sheet picking unit 22, a controller 24, a mid-frame 26 and a media source 28.

Media source 28 is configured to receive a plurality of print medium sheets from which a print medium, i.e., an individual print medium sheet 30, is picked by sheet picking unit 22 and transported to feed roller unit 20, which in turn further transports print medium sheet 30 during an imaging operation. Print medium sheet 30 may be, for example, plain paper, coated paper, photo paper or transparency media.

Printhead carrier system 18 includes a printhead carrier 32 for mounting and carrying a color printhead 34 and/or a monochrome printhead 36. A color ink reservoir 38 is provided in fluid communication with color printhead 34, and a monochrome ink reservoir 40 is provided in fluid communication with monochrome printhead 36. Those skilled in the art will recognize that color printhead 34 and color ink reservoir 38 may be formed as individual discrete units, or may be combined as an integral unitary printhead cartridge. Likewise, monochrome printhead 36 and monochrome ink reservoir 40 may be formed as individual discrete units, or may be combined as an integral unitary printhead cartridge.

Printhead carrier system 18 further includes a reflectance sensor 42 attached to printhead carrier 32. Reflectance sensor 42 may be, for example, a unitary optical sensor including a light source, such as a light emitting diode (LED), and a reflectance detector, such as a phototransistor. The reflectance detector is located on the same side of a media as the light source. The operation of such sensors is well known in the art, and thus, will be discussed herein to the extent necessary to relate the operation of reflectance sensor 42 to the operation of the present invention. For example, the LED of reflectance sensor 42 directs light at a predefined angle onto a reference surface, such as the surface of print medium sheet 30, and at least a portion of light reflected from the surface is received by the reflectance detector of reflectance sensor 42. The intensity of the reflected light received by the reflectance detector varies with the density of a printed image present on print medium sheet 30. The light received by the reflectance detector of reflectance sensor 42 is converted to an electrical signal by the reflectance detector of reflectance sensor 42. The signal generated by the reflectance detector corresponds to the reflectivity from print medium sheet 30, including any image scanned by reflectance sensor 42. Thus, as used herein, the term “reflectivity” refers to the intensity of the light reflected from the print medium and/or image scanned by reflectance sensor 42, which may be used in accordance with the present invention in dot size determination.

Printhead carrier 32 is guided by a pair of guide members 44, 46, which may be, for example, in the form of guide rods. Each of guide members 44, 46 includes a respective horizontal axis 44a, 46a. Printhead carrier 32 includes a pair of guide member bearings 48, 50, each of guide member bearings 48, 50 including a respective aperture for receiving guide member 44. The horizontal axis 44a of guide member 44 generally defines a bi-directional scan path 52 for printhead carrier 32. Accordingly, scan path 52 is associated with each of printheads 34, 36 and reflectance sensor 42.

Printhead carrier 32 is connected to a carrier transport belt 53 via a carrier drive attachment device 54. Carrier transport belt 53 is driven by a carrier motor 55 via a carrier pulley 56. Carrier motor 55 has a rotating carrier motor shaft 58 that is attached to carrier pulley 56. Carrier motor 55 can be, for example, a direct current (DC) motor or a stepper motor. At the directive of controller 24, printhead carrier 32 is transported in a reciprocating manner along guide members 44, 46, and in turn, along scan path 52.

The reciprocation of printhead carrier 32 transports ink jet printheads 34, 36 and reflectance sensor 42 across the print medium sheet 30, such as paper, along scan path 52 to define a print/sense zone 60 of imaging apparatus 14. The reciprocation of printhead carrier 32 occurs in a main scan direction (bi-directional) that is parallel with bi-directional scan path 52, and is also commonly referred to as the horizontal direction, including a left-to-right carrier scan direction 62 and a right-to-left carrier scan direction 63. Generally, during each scan of printhead carrier 32 while printing or sensing, the print medium sheet 30 is held stationary by feed roller unit 20.

Mid-frame 26 provides support for the print medium sheet 30 when the print medium sheet 30 is in print/sense zone 60, and in part, defines a portion of a print medium path 64 of imaging apparatus 14.

Feed roller unit 20 includes a feed roller 66 and corresponding index pinch rollers (not shown). Feed roller 66 is driven by a drive unit 68. The index pinch rollers apply a biasing force to hold the print medium sheet 30 in contact with respective driven feed roller 66. Drive unit 68 includes a drive source, such as a stepper motor, and an associated drive mechanism, such as a gear train or belt/pulley arrangement. Feed roller unit 20 feeds the print medium sheet 30 in a sheet feed direction 70, designated as an X in a circle to indicate that the sheet feed direction is out of the plane of FIG. 1 toward the reader. The sheet feed direction 70 is commonly referred to as the vertical direction, which is perpendicular to the horizontal bi-directional scan path 52, and in turn, is perpendicular to the horizontal carrier scan directions 62, 63. Thus, with respect to print medium sheet 30, carrier reciprocation occurs in a horizontal direction and media advance occurs in a vertical direction, and the carrier reciprocation is generally perpendicular to the media advance.

Controller 24 includes a microprocessor having an associated random access memory (RAM) and read only memory (ROM). Controller 24 is electrically connected and communicatively coupled to printheads 34, 36 via a communications link 72, such as for example a printhead interface cable. Controller 24 is electrically connected and communicatively coupled to carrier motor 55 via a communications link 74, such as for example an interface cable. Controller 24 is electrically connected and communicatively coupled to drive unit 68 via a communications link 76, such as for example an interface cable. Controller 24 is electrically connected and communicatively coupled to sheet picking unit 22 via a communications link 78, such as for example an interface cable. Controller 24 is electrically connected and communicatively coupled to reflectance sensor 42 via a communications link 80, such as for example an interface cable.

Controller 24 executes program instructions to effect the printing of an image on the print medium sheet 30, such as for example, by selecting the index feed distance of print medium sheet 30 along print medium path 64 as conveyed by feed roller 66, controlling the acceleration rate and velocity of printhead carrier 32, and controlling the operations of printheads 34, 36, such as for example, by controlling the fire time of individual nozzles of printhead 34 and/or printhead 36. As used herein, the term “fire time” is the time between firings of a nozzle of a printhead in forming adjacent dots on the same scan line of an image. In addition, controller 24 executes instructions to perform dot size determination in accordance with the present invention, based on reflectance data received from reflectance sensor 42.

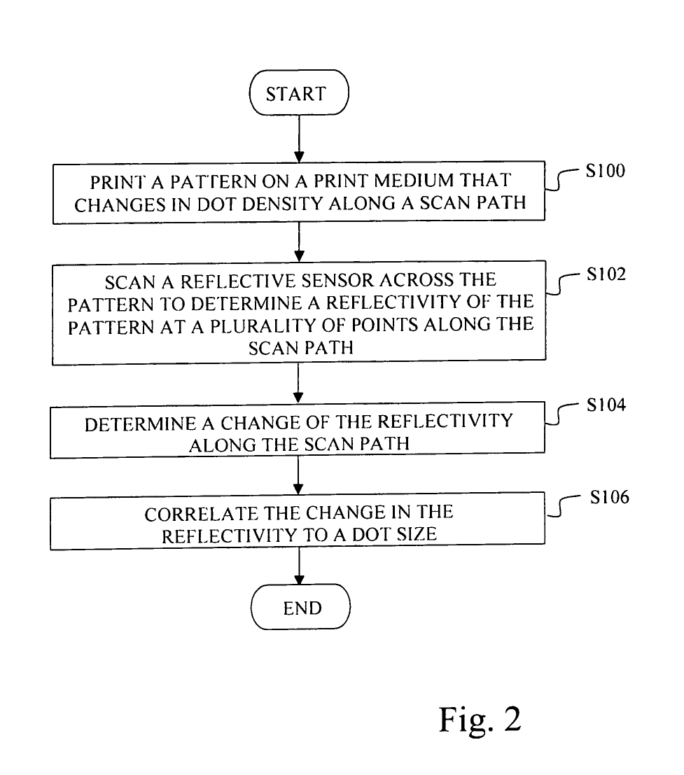

FIG. 2 is a flowchart depicting a general method of dot size determination in accordance with the present invention. The operation of the invention will be further described with respect to FIGS. 1 and 3-9.

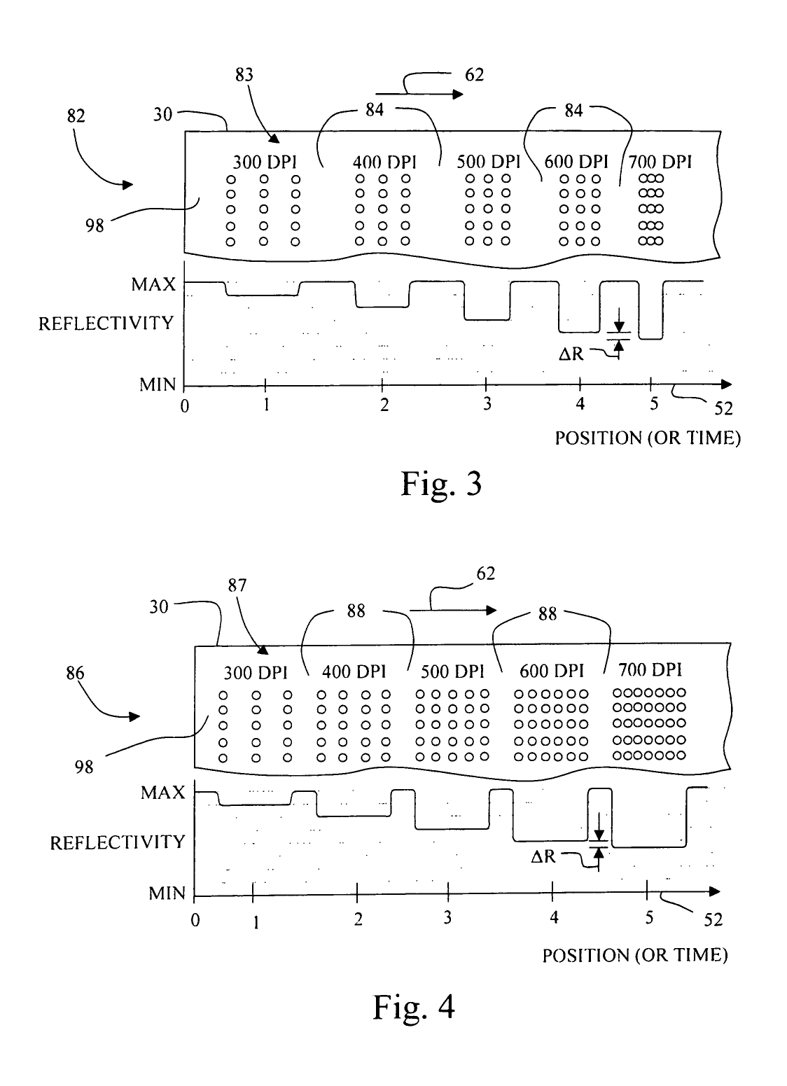

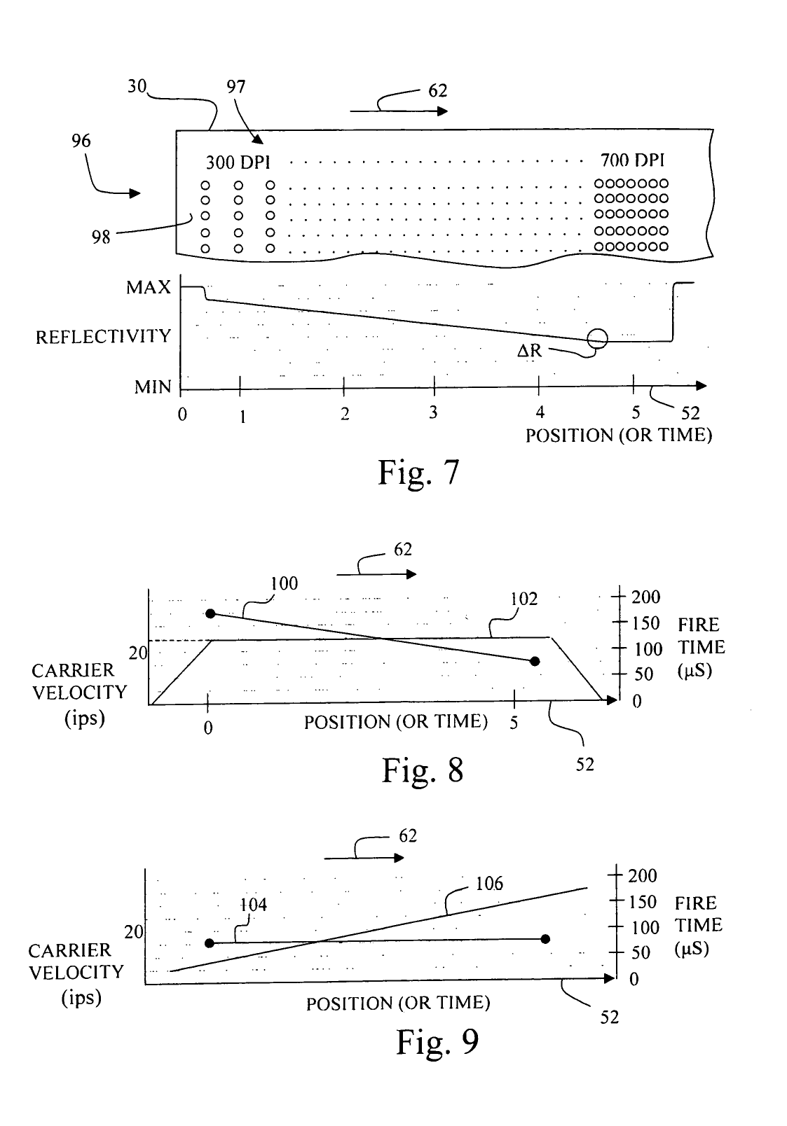

At step S100, a pattern is printed on a print medium, such as print medium sheet 30, that changes in dot density along scan path 52. FIGS. 3, 4, 5 and 7 each illustrate a different exemplary printed pattern. FIG. 6 is a graph that illustrates a relationship between printhead carrier velocity and fire time for the nozzles of a printhead, such as one of printheads 34 and 36, which may be used in generating the printed patterns of FIGS. 3-5. FIG. 8 is a graph that illustrates a relationship between printhead carrier velocity and fire time for the nozzles of a printhead, such as one of printheads 34 and 36, which may be used in generating the printed pattern of FIG. 7. FIG. 9 is a graph that illustrates a relationship between printhead carrier velocity and fire time for the nozzles of a printhead, such as one of printheads 34 and 36, as an alternative to that shown in FIG. 8.

FIG. 3 shows a printed pattern 82 including a plurality of print areas 83, wherein the dot density increases in step increments in direction 62. The various dot densities of print areas 83 of pattern 82 are labeled in FIG. 3 with exemplary values to aid in understanding the invention. As shown in this example, the dot density increases from left-to-right in direction 62 in the step increments of 300 dpi (dots per inch), 400 dpi, 500 dpi, 600 dpi and 700 dpi. A gap 84 is provided between each discrete dot density change.

FIG. 4 shows a printed pattern 86 including a plurality of print areas 87, wherein the dot density increases in step increments in direction 62. The various exemplary dot densities of print areas 87 of pattern 86 may be the same as in FIG. 3, as shown. FIG. 4 includes a gap 88 between each discrete dot density change of the plurality of print areas 87 of printed pattern 86. Printed pattern 86 of FIG. 4 differs from printed pattern 82 of FIG. 3, however, in that each of print areas 87 of printed pattern 86 are of substantially the same area coverage.

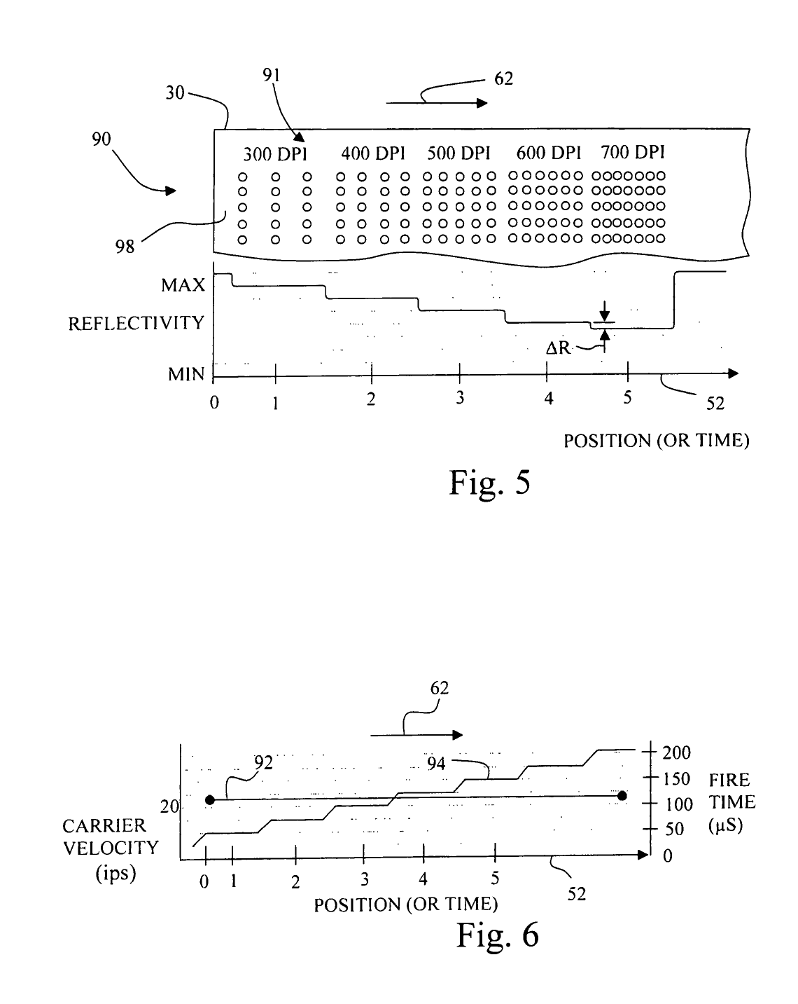

FIG. 5 shows a printed pattern 90 including a plurality of print areas 91, wherein the dot density increases in step increments in direction 62. The various exemplary dot densities of print areas 91 of pattern 90 may be the same as in FIGS. 3 and 4, as shown. FIG. 5 differs from FIGS. 3 and 4, however, in that no gaps are formed between each discrete dot density change, as is the case in FIGS. 3 and 4.

As illustrated in FIG. 6, a waveform 92 is shown having a slope of zero, and a waveform 94 is shown as having step increments. In one embodiment, the printed patterns of FIGS. 3-5 may be printed wherein waveform 92 represents a constant fire time for the nozzles of the printhead, such as one of printheads 34, 36, and waveform 94 represents a step increment change, e.g., increase as shown, in the carrier velocity (in inches per second, i.e., ips) of printhead carrier 32. Alternatively, the printed patterns of FIGS. 3-5 may be printed wherein the carrier velocity of printhead carrier 32 is constant and the fire time for the nozzles of the printhead, such as one of printheads 34, 36, decreases in step increments in direction 62.

As a further alternative, the step increases in printhead carrier velocity illustrated in FIG. 6 in waveform 94 may be emulated by achieving each printhead carrier velocity step on a separate cycle of acceleration, steady state velocity, and deceleration of printhead carrier 32, with only the portion of the pattern corresponding to a particular printhead carrier steady state velocity being printed for that particular steady state velocity. This could occur with multiple cycles in a single pass of printhead carrier 32, multiple cycles in multiple passes of printhead carrier 32, or in a single cycle in multiple passes of printhead carrier 32.

As a specific example for using a single cycle in multiple passes of printhead carrier 32, with respect to FIGS. 3 and 6, on a first pass of printhead carrier 32 at a first steady state printhead carrier velocity, only the 300 dpi portion of print area 83 of printed pattern 82 is printed. On a subsequent pass of printhead carrier 32 at a second steady state printhead carrier velocity, only the 400 dpi portion of print area 83 of printed pattern 82 is printed. This sequence would continue until printed pattern 82 is complete.

FIG. 7 shows a printed pattern 96 including a plurality of print areas 97, wherein the dot density increases in a continuous manner in direction 62, from a lowest dot density to a highest dot density used in dot size determination. The various dot densities of print areas 97 of pattern 96 are labeled in FIG. 7 with exemplary values to aid in understanding the invention. As shown in this example, the dot density increases in a continuous manner from left-to-right in direction 62 from 300 dpi to 700 dpi.

As illustrated in FIG. 8, the printed pattern of FIG. 7 may be printed wherein a waveform 100 represents a continuous decrease in the fire time for the nozzles of the printhead, such as one of printheads 34, 36, and a waveform 102 represents the carrier velocity of printhead carrier 32, with printhead carrier 32 having reached a constant velocity during the continuous decrease in the fire time for the nozzles of the printhead. Alternatively, as illustrated in FIG. 9, the printed pattern of FIG. 7 may be printed wherein the fire time for the nozzles of the printhead, such as one of printheads 34, 36, represented by waveform 104, is constant, and the carrier velocity, represented by waveform 106, continuously increases during the constant fire time for the nozzles of the printhead.

Referring again to FIG. 1, while the dot density in each of the examples of FIGS. 3-5 and 7 increases in direction 62, the printing of patterns 82, 86, 90 and 96, may occur in either of directions 62, 63, or bi-directionally. Further, one skilled in the art will recognize that patterns may be generated wherein the dot density decreases in direction 62, while still applying the principles of the present invention.

At step S102, reflectance sensor 42 is scanned across the pattern, e.g., one of patterns 82, 86, 90 and 96, to determine a reflectivity of the pattern at a plurality of points along scan path 52.

Each of the FIGS. 3-5 and 7 includes a graph illustrating a reflectivity associated with a respective one of exemplary patterns 82, 86, 90 and 96. Prior to performing reflectivity measurements using reflectance sensor 42, it may be desirable to calibrate the output of reflectance sensor 42 with respect to the print medium type and the ink that will be used, although the present invention may be practiced without pre-calibrating reflectance sensor 42.

In the graphs of FIGS. 3-5 and 7, maximum reflectivity (MAX) occurs where there is an extent of print medium sheet 30 with no printed image, such as for example, in margin 98, or in gaps 84 and 88 of FIGS. 3 and 4, respectively. Minimum reflectivity (MIN) may correspond to an area on print medium sheet 30 (theoretical or actual) that is printed with 100 percent coverage (i.e., is printed solid). As shown in each of FIGS. 3-5 and 7, as the dot density increases, the associated reflectivity decreases.

In each of FIGS. 3-5, the dot density increases in a step manner in direction 62, and thus the reflectivity decreases in a step manner in direction 62. Accordingly, the reflectivity measurements conducted by reflectance sensor 42 may be controlled by controller 24 to be performed at enumerated points 1, 2, 3, 4 and 5 along scan path 52. The enumerated points 1, 2, 3, 4 and 5 along scan path 52 may be representative of a position of printhead carrier 32 along scan path 52, e.g., a distance relative to a carrier home position, or alternatively, may be representative of a time of travel for printhead carrier 32 along scan path 52, e.g., a time of travel relative to the carrier home position.

In FIG. 7, the dot density increases in a continuous manner in direction 62, and thus, the reflectivity decreases in a continuous manner in direction 62. Accordingly, the reflectivity measurements conducted by reflectance sensor 42 may be controlled by controller 24 to be performed at enumerated points 1, 2, 3, 4 and 5 along scan path 52, or more ideally, may be performed continuously along scan path 52.

At step S104, a change of the reflectivity (AR) along scan path 52 is determined. The change of the reflectivity (AR) may be calculated by controller 24, and may be stored in an associated memory. Alternatively, the change of the reflectivity (AR) may be calculated by host 12, and may be stored in an associated memory.

With each of the printed patterns 82, 86 and 90 of FIGS. 3-5, the change of the reflectivity (AR) is characterized by a difference in the reflectivity measured by reflectance sensor 42 at adjacent points along scan path 52, such as for example, at enumerated adjacent points 1, 2; 2, 3; 3,4; and 4,5.

With the printed pattern 96 of FIG. 7, the change of the reflectivity (AR) also is characterized by a difference in the reflectivity measured by reflectance sensor 42 at adjacent points along scan path 52, such as for example, at adjacent enumerated points 1, 2; 2, 3; 3, 4; and 4, 5. More ideally, for pattern 96, the change of the reflectivity (ΔR) is measured more often than at enumerated points 1, 2, 3, 4 and 5, such as for example, by providing substantially constant sampling of reflectivity along scan path 52.

At step S106, the change in reflectivity (ΔR) is correlated to a dot size. Such a correlation may be performed, for example, by comparing the change in reflectivity (ΔR) to a threshold (T), and if the change in reflectivity (ΔR) has reached threshold T, then a dot density associated with one of the adjacent points is identified. The determination of whether threshold (T) has been reached may be based, for example, on the change in reflectivity (ΔR) being equal to threshold (T), or the change in reflectivity (ΔR) being less than threshold (T). Threshold (T) may be some predetermined value, such as a change of 0 to 5 percent.

Thereafter, a dot size determination may be made through a calculation, or alternatively, through reference to a look-up table stored in memory, such as in a memory of one of imaging apparatus 14 or host 12, based on the identified dot density of the selected one of the adjacent points.

In the case of a calculation, for example, a reciprocal of the dot density that was identified with respect one of the adjacent points is taken to determine the dot size. More particularly with respect to this example, with respect to FIGS. 3-5, assume that the change in reflectivity (ΔR) reaches threshold (T) at adjacent points 4 and 5 along scan path 52. Then, the dot size may be calculated by taking the reciprocal of the dot density (700 dpi) associated with position 5, yielding a dot size of one-seven hundredth ( 1/700) of an inch. Alternatively, the dot density identified may correspond to a point of the adjacent points having the lowest dot density, in this example, position 4. A determination as to whether to use the lowest dot density of the adjacent points or the highest dot density of the adjacent points may be determined empirically, so as to provide the most accurate representation of dot size.

In the case of a look-up table, for example, the dot size for a particular dot density may be predetermined and stored in the look-up table resident in one of imaging apparatus 14 and host 12. By using the dot density at the point along scan path 52 identified above, a location in the look-up table containing a dot size associated with the dot density is accessed, and the dot size information is retrieved.

While this invention has been described with respect to embodiments of the present invention, the present invention can be further modified within the spirit and scope of this disclosure. For example, while the present invention was described with respect to an imaging apparatus as an ink jet printer, those skilled in the art will recognize that the principles of the present invent may be readily applied to other imaging technologies, such as for example, electrophotographic imaging (e.g., a laser printer). This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A method of dot size determination, comprising the steps of:
printing a pattern on a print medium that changes in dot density along a scan path;
scanning a reflectance sensor across said pattern to determine a reflectivity of said pattern at a plurality of points along said scan path;
determining a change of said reflectivity along said scan path; and
correlating said change in said reflectivity to a dot size.

2. The method of claim 1, said pattern including a plurality of print areas, wherein each area of said plurality of print areas has a different dot density.

3. The method of claim 1, wherein said pattern is printed by changing a print resolution of an imaging apparatus as said pattern is printed along said scan path.

4. The method of claim 3, wherein said imaging apparatus changes said print resolution in step increments along said scan path to form a plurality of print areas at differing dot densities.

5. The method of claim 4, wherein said plurality of points along said scan path where said reflectance sensor determines said reflectivity of said pattern corresponds to said plurality of print areas having said differing dot densities.

6. The method of claim 3, wherein the act of changing said print resolution of said imaging apparatus is effected by changing a fire time of a printhead, while maintaining a constant printhead carrier velocity.

7. The method of claim 3, wherein the act of changing said print resolution of said imaging apparatus is effected by changing a printhead carrier velocity along said scan path, while providing a constant fire time for a printhead.

8. The method of claim 7, wherein said changing of said printhead carrier velocity occurs in step changes in velocity along said scan path.

9. The method of claim 8, wherein each of said step changes in velocity is achieved by performing a separate cycle of acceleration, steady state velocity, and deceleration of a printhead carrier.

10. The method of claim 8, wherein each of said step changes in velocity is achieved on a separate pass of a printhead carrier in printing said pattern.

11. The method of claim 1, wherein the act of determining said change of said reflectivity along said scan path comprises comparing a reflectivity determined at one of said plurality of points with at least one other reflectivity determined for at least one other of said plurality of points.

12. The method of claim 1, wherein the act of determining said change of said reflectivity along said scan path occurs with respect to adjacent points of said plurality of points, said method further comprising the step of comparing said change of said reflectivity to a threshold, and if said change of reflectivity has reached said threshold, then identifying a dot density associated with one of said adjacent points.

13. The method of claim 12, wherein the act of correlating said change in said reflectivity to said dot size comprises taking a reciprocal of said dot density associated with the one of said adjacent points that was identified.

14. The method of claim 12, wherein said dot density that was identified corresponds to a point of said adjacent points having the lowest dot density.

15. The method of claim 12, wherein said dot density that was identified corresponds to a point of said adjacent points having the highest dot density.

16. The method of claim 12, wherein a determining of whether said threshold is reached is based on said change in reflectivity being one of equal to or less than said threshold.

17. The method of claim 1, wherein said method is implemented by at least one of an imaging apparatus and a host.

18. An apparatus configured for implementing a method of dot size determination, comprising the steps of:
printing a pattern on a print medium that changes in dot density along a scan path;
scanning a reflectance sensor across said pattern to determine a reflectivity of said pattern at a plurality of points along said scan path;
determining a change of said reflectivity along said scan path; and
correlating said change in said reflectivity to a dot size.

19. The apparatus of claim 18, said pattern including a plurality of print areas, wherein each area of said plurality of print areas has a different dot density.

20. The apparatus of claim 18, wherein said pattern is printed by changing a print resolution of an imaging apparatus as said pattern is printed along said scan path.

21. The apparatus of claim 20, wherein said imaging apparatus changes said print resolution in step increments along said scan path to form a plurality of print areas at differing dot densities.

22. The apparatus of claim 21, wherein said plurality of points along said scan path where said reflectance sensor determines said reflectivity of said pattern corresponds to said plurality of print areas having said differing dot densities.

23. The apparatus of claim 20, wherein the act of changing said print resolution of said imaging apparatus is effected by changing a fire time of a printhead, while maintaining a constant printhead carrier velocity.

24. The apparatus of claim 20, wherein the act of changing said print resolution of said imaging apparatus is effected by changing a printhead carrier velocity along said scan path, while providing a constant fire time for a printhead.

25. The apparatus of claim 24, wherein said changing of said printhead carrier velocity occurs in step changes in velocity along said scan path.

26. The apparatus of claim 25, wherein each of said step changes in velocity is achieved by performing a separate cycle of acceleration, steady state velocity, and deceleration of a printhead carrier.

27. The apparatus of claim 25, wherein each of said step changes in velocity is achieved on a separate pass of a printhead carrier in printing said pattern.

28. The apparatus of claim 18, wherein the act of determining said change of said reflectivity along said scan path comprises comparing a reflectivity determined at one of said plurality of points with at least one other reflectivity determined for at least one other of said plurality of points.

29. The apparatus of claim 18, wherein the act of determining said change of said reflectivity along said scan path occurs with respect to adjacent points of said plurality of points, said method further comprising the step of comparing said change of said reflectivity to a threshold, and if said change of reflectivity has reached said threshold, then identifying a dot density associated with one of said adjacent points.

30. The apparatus of claim 29, wherein the act of correlating said change in said reflectivity to said dot size comprises taking a reciprocal of said dot density associated with the one of said adjacent points that was identified.

31. The apparatus of claim 29, wherein said dot density that was identified corresponds to a point of said adjacent points having the lowest dot density.

32. The apparatus of claim 29, wherein said dot density that was identified corresponds to a point of said adjacent points having the highest dot density.

33. The apparatus of claim 29, wherein a determining of whether said threshold is reached is based on said change in reflectivity being one of equal to or less than said threshold.

34. The apparatus of claim 18, wherein said apparatus is at least one of an imaging apparatus and a host.

35. The apparatus of claim 18, comprising a controller configured to execute program instructions for effecting said steps.
